(19) United States
(12) Patent Application Publication
(10) Pub. No.: US 2010/0053270 A1
(43) Pub. Date: Mar. 4, 2010

(54) PRINTHEAD HAVING CONVERGING DIVERGING NOZZLE SHAPE

(76) Inventors: Jinquan Xu, Rochester, NY (US); Zhanjun Gao, Rochester, NY (US); Kevin P. Egan, Tipp City, OH (US); David J. Stephens, Springboro, OH (US)

Correspondence Address: Andrew J. Anderson;Patent Legal Staff, Eastman Kodak Company, 343 State Street, Rochester, NY, 14650-2201, US

(21) Appl. No.: 12/200,182

(22) Filed: Aug. 28, 2008

(51) Int. Cl. B41J 2/14

(52) U.S. Cl. 347/47

(57) ABSTRACT

A printhead includes a nozzle plate and a nozzle bore located in the nozzle plate. In one embodiment, the nozzle bore includes a first section, a second section, and a third section when viewed in a plane perpendicular to the nozzle plate. The first section and the second section are spaced apart from each other by the third section. The first section includes a converging area portion and the second section includes a diverging area portion. In another embodiment, the first section and the second section of the nozzle bore are adjacent to each other. The first section includes a converging area portion and the second section includes a diverging area portion. The diverging area portion and the converging area portion are asymmetrical relative to each other when viewed along the plane perpendicular to the nozzle plate.

### FIELD OF THE INVENTION

The invention relates generally to printheads, and in particular to the shape of printhead nozzles.

### BACKGROUND OF THE INVENTION

Ink jet printing systems can be categorized as either continuous (CIJ) or Drop-on-Demand (DOD). Both types of systems include one or more printheads. Each printhead includes one or more nozzles with arrays of nozzles being typically provided in a nozzle plate.

The shapes and dimensions of the ink nozzles strongly affect characteristics of the ink drops ejected. For example, if the diameter of a nozzle opening deviates from a desired size, ink drop volume and the velocity can vary from the desired values. If the opening of a nozzle is formed with an irregular shape, the trajectory of ejected ink drops can deviate from a desired direction (typically, normal to the plane of the nozzle plate). The shapes of a nozzle bore also can affect ink flow fields within a nozzle which, in turn, can impact nozzle life span, nozzle tolerance to particle contamination, and nozzle maintenance.

Accordingly, there is an ongoing need for optimization of nozzle bore shape in printheads used in ink jet printing systems.

### SUMMARY OF THE INVENTION

According to one aspect of the present invention, a printhead includes a nozzle plate and a nozzle bore located in the nozzle plate. The nozzle bore includes a first section, a second section, and a third section when viewed in a plane perpendicular to the nozzle plate. The first section and the second section are spaced apart from each other by the third section. The first section includes a converging area portion and the second section includes a diverging area portion.

According to another aspect of the present invention, a method of ejecting a liquid drop from a printhead includes providing a printhead including a nozzle plate; and a nozzle bore located in the nozzle plate, the nozzle bore including a first section, a second section, and a third section when viewed in a plane perpendicular to the nozzle plate, the first section and the second section being spaced apart from each other by the third section, the first section including a converging area portion, the second section including a diverging area portion; providing a source of liquid in fluid communication with the printhead; causing the liquid to be ejected through the nozzle bore of the printhead; and causing a drop to form from the liquid by actuating a drop forming mechanism associated with the nozzle bore of the printhead.

According to another aspect of the present invention, a printhead includes a nozzle plate and a nozzle bore located in the nozzle plate. The nozzle bore includes a first section and a second section when viewed in a plane perpendicular to the nozzle plate. The first section and the second section are adjacent to each other. The first section includes a converging area portion and the second section includes a diverging area portion. The diverging area portion of the second section and the converging area portion of the first section are asymmetrical relative to each other when viewed along the plane perpendicular to the nozzle plate.

According to another aspect of the present invention, a method of ejecting a liquid drop from a printhead includes providing a printhead including a nozzle plate having a surface; and a nozzle bore located in the nozzle plate, the nozzle bore including a first section and a second section when viewed in a plane perpendicular to the nozzle plate, the first section and the second section being adjacent to each other, the first section including a converging area portion, the second section including a diverging area portion, the diverging area portion of the second section and the converging area portion of the first section being asymmetrical relative to each other when viewed along the plane perpendicular to the nozzle plate; providing a source of liquid in fluid communication with the printhead; causing the liquid to be ejected through the nozzle bore of the printhead; and causing a drop to form from the liquid by actuating a drop forming mechanism associated with the nozzle bore of the printhead.

### BRIEF DESCRIPTION OF THE DRAWINGS

In the detailed description of the example embodiments of the invention presented below, reference is made to the accompanying drawings, in which:

FIG. 1A is a schematic two-dimensional view of a printhead with a nozzle plate including an example embodiment of the present invention;

FIG. 1B is a schematic three-dimensional view of a nozzle plate including an example embodiment of the present invention;

FIG. 2A is a schematic three-dimensional view of an example embodiment of the present invention;

FIG. 2B is a schematic two-dimensional cross sectional view of the nozzle plate shown in FIG. 2A taken along line B-B;

FIG. 2C is a schematic two-dimensional cross sectional view of the nozzle plate shown in FIG. 2A taken along line C-C;

FIG. 2D is a schematic two-dimensional cross-sectional view of another example embodiment of the present invention taken along line C-C as shown in FIG. 2A;

FIG. 2E is a schematic view of another example embodiment of the present invention;

FIG. 2F is a schematic two-dimensional cross-sectional view of another example embodiment of the present invention taken along line F-F as shown in FIG. 2E;

FIG. 3 is a schematic two-dimensional cross-sectional view of the example embodiment shown in FIGS. 2A and 2B including an ink filament and an ink drop produced by actuation of a drop forming mechanism;

FIG. 4 is a schematic two-dimensional cross-sectional view of another example embodiment of the present invention;

FIG. 5 is a schematic two-dimensional cross-sectional view of another example embodiment of the present invention;

FIG. 6 is a schematic two-dimensional cross-sectional view of another example embodiment of the present invention; and

FIG. 7 is a schematic two-dimensional cross-sectional view of another example embodiment of the present invention.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

The example embodiments of the present invention are illustrated schematically and not to scale for the sake of clarity. One of the ordinary skills in the art will be able to readily determine the specific size and interconnections of the elements of the example embodiments of the present invention. In the following description, identical reference numerals have been used, where possible, to designate identical elements.

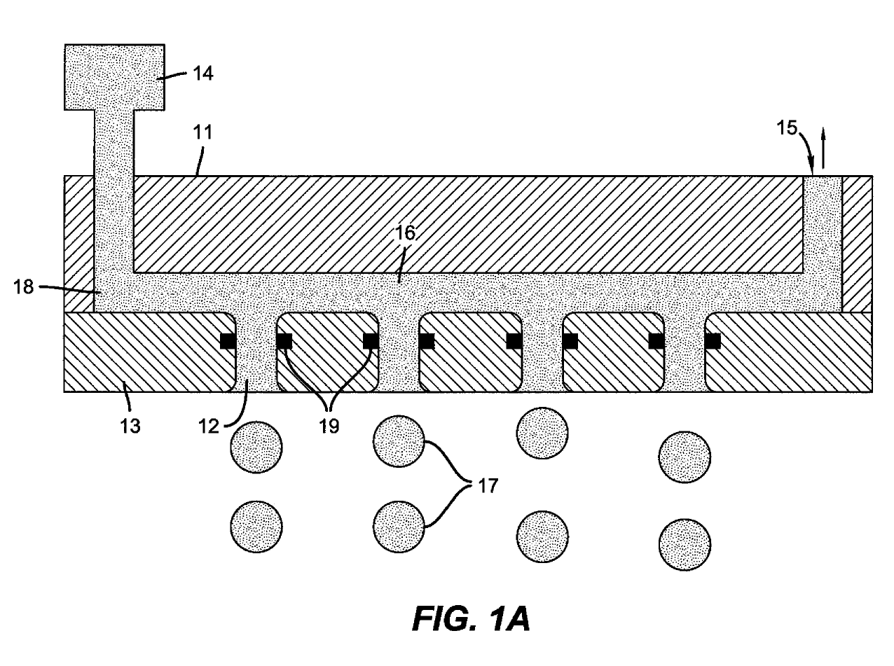

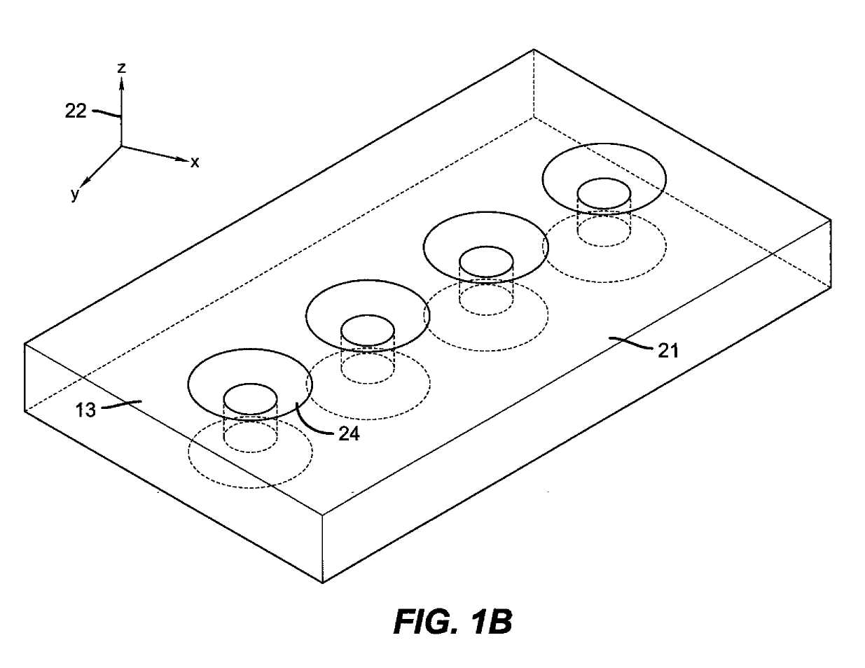

Referring to FIGS. 1A and 1B, schematic views of a printhead 11 with a nozzle plate 13 including an example embodiment of the present invention are shown. Printhead 11 includes a nozzle plate 13 and a fluidic supply channel 16. A liquid 18, for example, ink, flows through fluidic supply channel 16 from a liquid flow source 14. A portion of the liquid 18 is ejected or jetted through nozzle bores 12, commonly referred to as nozzles, and forms drops 17, while the remaining liquid flows through outlet 15 to be returned to source 14 or collected in another container (not shown). Nozzle plate 13 is mounted to printhead 11. However, nozzle plate 13 can be integrally formed to printhead 11.

Drops 17 are formed or generated using conventional drop-forming mechanisms 19, for example, thermal actuators, piezoelectric actuators, etc., located to be operatively associated with nozzle bores 12. Typically, drop forming mechanisms 19 are located in nozzle plate 13 or in fluidic supply channel 16. For example, in FIG. 1A, drop forming mechanisms 19 are heaters located in nozzle plate 13.

Printhead 11 can be monolithic or group together to form a tiled or stitched printhead. Additionally, printhead 11 can be a scanning type printhead or a stationary printhead and can be incorporated in either a drop on demand printing system or a continuous jetting printing system.

Referring to FIG. 1B, nozzle plate 13 includes surface 21 and nozzle bores 24 arranged in an array. A Cartesian coordinate system x-y-z 22 is also shown in FIG. 1B in order to show the relative orientations of the cross sections shown in subsequent figures and described herein. The three principle planes of the Cartesian coordinate system, plane x-y, plane x-z, or plane y-z, are used to represent the cross-sectional views of the nozzle bore 24 that follow.

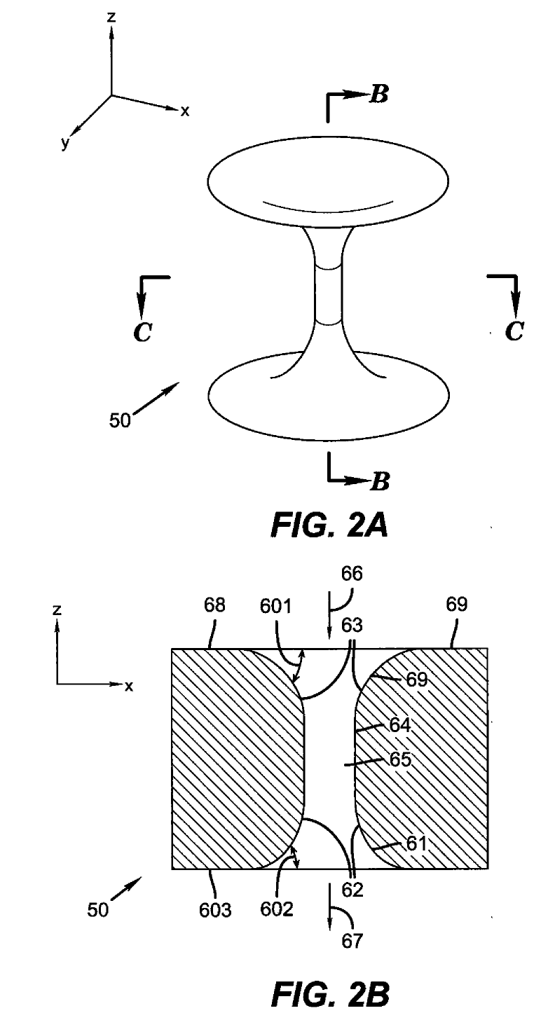

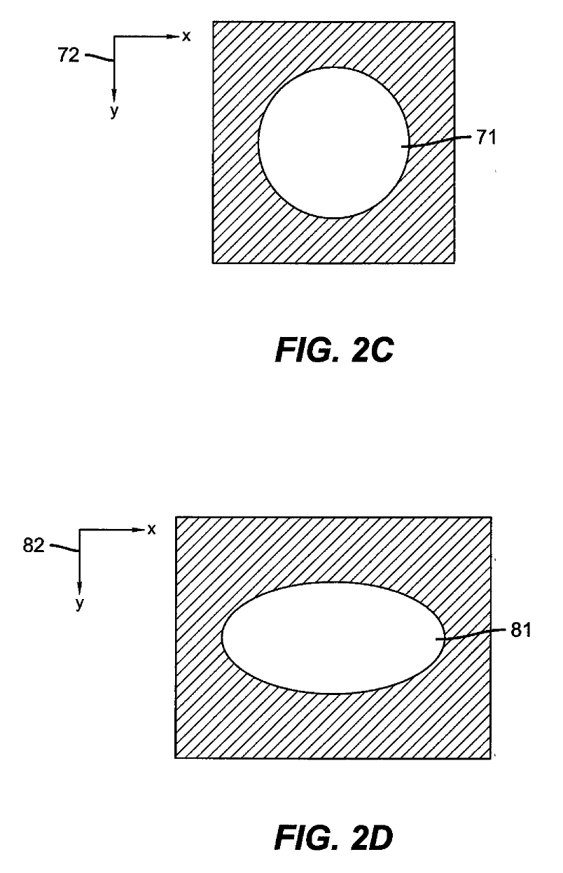

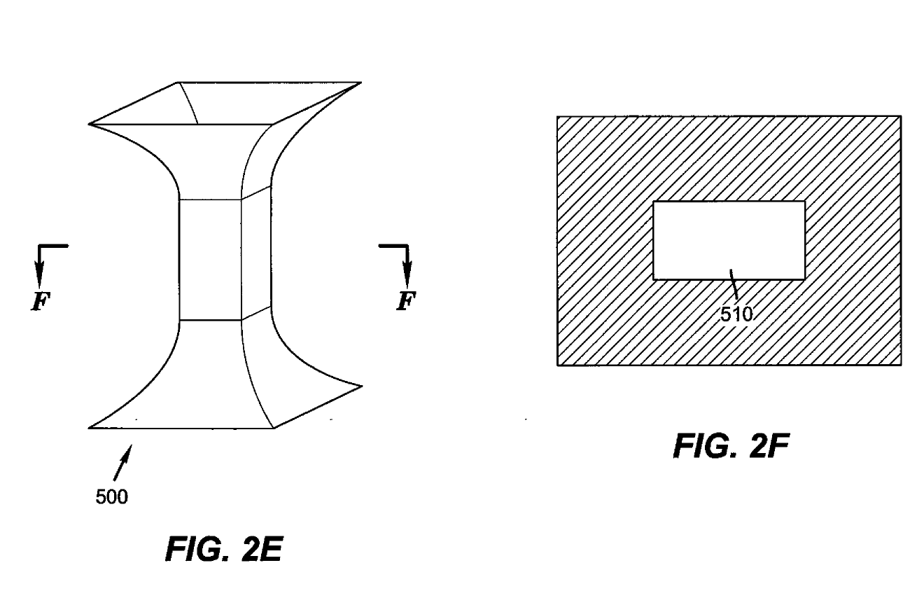

Referring to FIGS. 2A and 2B, schematic views of an example embodiment of the present invention are shown. A nozzle bore 50 is formed in nozzle plate 13. Nozzle bore 50 includes a first section 63, a second section 62, and a third section 65 as viewed in a plane perpendicular to the nozzle plate at the ink inlet side (represented by arrow 66) and/or the ink outlet side (represented by arrow 67). The first section 63 includes a converging area portion 69 and the second section 62 includes a diverging area portion 61. As viewed from the direction of ink flow (represented by arrows 66 and 67) through nozzle bore 50, the cross section of the converging area portion 69 of the nozzle bore decreases and the cross section of the diverging area portion 61 of the nozzle bore increases.

The converging area portion 69 includes an acute angle 601 relative to the surface 68 of the nozzle plate, and the diverging area portion 61 includes an acute angle 602 relative to the surface 68 of the nozzle plate. At least one of the converging area portion 69 and the diverging area portion 61 includes a surface having a continuous radius of curvature, i.e., the first order derivatives of the curved surface of the converging area portion 69 and the diverging area portion 61 are continuous.

In FIG. 2B, surface 68 is the surface of nozzle plate 13 that forms part of fluidic supply channel 16 and surface 603 is the external surface of nozzle plate 13. Angle 602 is also acute relative to surface 603 of nozzle plate 13.

The first section 63 and the second section 62 are spaced apart from each other by a third section 65. The third section 65 includes a portion 64 that is perpendicular to the surface 68 of the nozzle plate. The converging area portion 69 and the diverging area portion 61 include surfaces having a continuous radius of curvatures, i.e., the first derivatives of the curved surface of the converging area portion 69 and the diverging area portion 61 are continuous. The acute angle 602 of the diverging area portion 61 is formed by the surface of the diverging area portion 61 having the continuous radius of curvature. The acute angle 601 of the converging area portion 69 is formed by the surface of the converging area portion 69 having the continuous radius of curvature.

Referring to FIG. 2C, third section 65 of nozzle bore 50 includes a circular shape 71 as viewed along a plane perpendicular to the nozzle plate, Cartesian coordinate Plane x-y 72. The first section 63 and the second section 62 of nozzle bore 50 can also have a circular shape 71.

Other cross sectional shapes are permitted. Referring to FIG. 2D, third section 65 of nozzle bore 50 includes an elliptical shape 81 as viewed along a plane perpendicular to the nozzle plate, Cartesian coordinate Plane x-y 82. The first section 63 and the second section 62 of nozzle bore 50 can also have a circular shape 71.

Combinations of cross sectional shapes, when viewed at different areas of nozzle bore 50, are also permitted. As such, cross-sectional shape can be circular only, elliptical only, or combinations of circular and elliptical, at different sections of nozzle bore 50. Typically, the shapes of the cross-sections are largely determined by drop characterization requirements and/or manufacturing processes.

Referring to FIGS. 2E and 2F, another example embodiment of the present invention is shown. Here, the cross-section is a quadrilateral shape 510 when viewed along a plane perpendicular to the nozzle plate. As described above, variations are permitted. For example, the cross-sections can be rectangle only, square only, or combinations of rectangle and square. Alternatively, cross-sections can includes polygons, for example pentagons or hexagons, depending on the specific application contemplated.

Referring back to FIGS. 1A-2E, the diverging area portion 61 and the converging area portion 69 are symmetrical (or mirror images) relative to each other when viewed along a plane parallel to the nozzle plate. However, the diverging area portion 61 and the converging area portion 69 can also be asymmetrical relative to each other when viewed along the plane perpendicular to the nozzle plate.

The converging area portion 69 and/or the diverging area portion 61 can be coated with hydrophobic or hydrophilic materials depending on the specific application contemplated. Other coatings can be applied on the converging area portion 69 and/or the diverging area portion 61 depending on the specific application contemplated. For example, diamond-like-carbon coating can be used to protect drop-forming mechanism(s) 19.

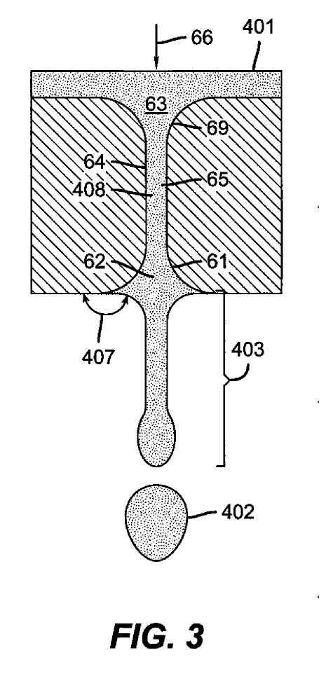

Referring to FIG. 3, ink 401 is shown jetting through nozzle bore 408 which is the same as nozzle bore 50 shown in FIGS. 2A and 2B. The nozzle bore 408 includes a first section 63 and a second section 62. The first section 63 includes a converging area portion 69 and the second portion 62 includes a diverging area portion 61. The first section 63 and the second section 62 are spaced apart from each other by a third section 65. The third section 65 includes a perpendicular area portion 64. Ink flows in the nozzle bore 408 from the ink inlet side 66. Liquid jet filament 403 breaks up into an ink drop(s) 402 when a drop generation mechanism (shown in FIG. 1A) is actuated.

The shape and length of break off of the liquid jet filament 403, its jetting velocity, and the shape and size of the resulting drop 402 vary depending on the shape and size of nozzle bore 408 as well as the type of drop generation mechanism used, etc. The flow pattern in the converging area portion 69 generates an ink fluid dynamics pattern that make particles (like pigments, or particle contamination) pass through the nozzle with less friction thereby increasing nozzle tolerance to particle contamination and nozzle life span. The same ink fluid dynamics pattern also facilitates ink refilling after each drop jetting.

The perpendicular area portion 64 accurately controls the jet direction, and the length of the perpendicular area portion 64 is used to control size of ink drops, and to minimize satellite drop formation. The diverging area portion 61 facilitates control of the jet filament 403 break off length.

The converging area portion 69, the perpendicular area portion 64 and the diverging area portion 61 can be coated with hydrophobic or hydrophilic materials depending on the specific application contemplated. The hydrodynamic property of coating layers can impact ink wet capability of the surfaces of the converging area portion 69 and the diverging area portion 61, and impact the contact angle 407 of the ink on the surface of the diverging area portion 61. The contact angle 407 in turn can change the jet filament 403 break off length. In applications where asymmetric deflection, as described in U.S. Pat. No. 6,079,821, is contemplated, coating hydrophobic or hydrophilic materials on the bore surface of the diverging area portion 61 can intentionally direct the ink drop 402 to a desired direction. The perpendicular area portion 64 can also be coated depending on the specific application contemplated.

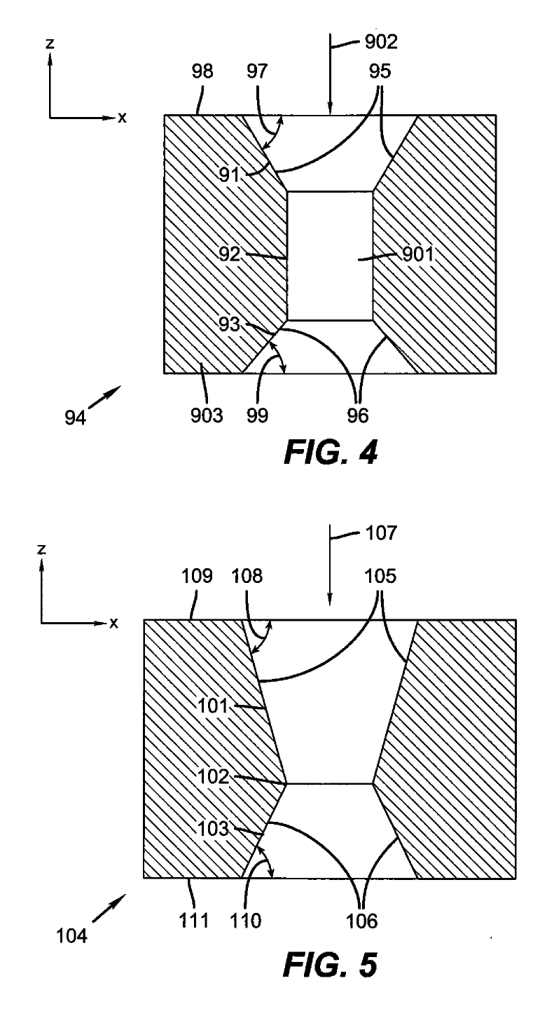

Referring to FIG. 4, another example embodiment of the present invention is shown. Nozzle bore 94 includes a first section 95 and a second section 96 as viewed in a plane perpendicular to the nozzle plate at the inlet side 902. The first section 95 includes a converging area portion 91 and the second portion 96 includes a diverging area portion 93. The converging area portion 91, a conical shape, includes an acute angle 97 relative to the surface of the nozzle plate 98, and the diverging area portion 93, an upside down conical shape, includes an acute angle 99 relative to surface 98 (or surface 903) of nozzle plate 13. Surfaces of the converging area portion 91 or the diverging area portion 93 are flat in Plane x-z, i.e., the first derivatives of the said surfaces are constant. The first section 95 and the second section 96 are spaced apart from each other by a third section 901. The third section 901 includes a portion 92 that is perpendicular to surface 98 of the nozzle plate 13. As described above, third section 901 helps to control drop sizes and jetting direction.

In FIG. 4, the diverging area portion 93 and the converging area portion 91 are symmetrical relative to each other when viewed along a plane parallel to the nozzle plate. However, the diverging area portion 93 and the converging area portion 91 can also be asymmetrical relative to each other when viewed along the plane perpendicular to the nozzle plate.

Example embodiments in which the diverging area portion and the converging area portion are asymmetrical relative to each other when viewed along the plane perpendicular to the nozzle plate are described with reference to FIGS. 5-7.

Referring to FIG. 5, another example embodiment of the present invention is shown. Nozzle bore 104 includes a first section 105 and a second section 106 as viewed in a plane perpendicular to the nozzle plate at the inlet side 107. The first section 105 includes a converging area portion 101 and the second section 106 includes a diverging area portion 103. The converging area portion 101 includes an acute angle 108 relative to the surface 109 of the nozzle plate 13, and the diverging area portion 103 includes an acute angle 110 relative to the surface 109 (or surface 111) of the nozzle plate 13. Surfaces of the converging area portion 101 and the diverging area portion 103 are flat in Plane x-z. The first section 105 and the second section 106 are adjacent to each other. First section 105 occupying more of the internal space of nozzle bore 104 than second section 106. In this sense first section 105 and second section 106 are asymmetric with respect to each other. Compared to FIG. 4, the removal of the third section 901 can be used to assist with drop deflection in applications which use drop deflection, for example, in asymmetric deflection applications like those described in U.S. Pat. No. 6,079,821.

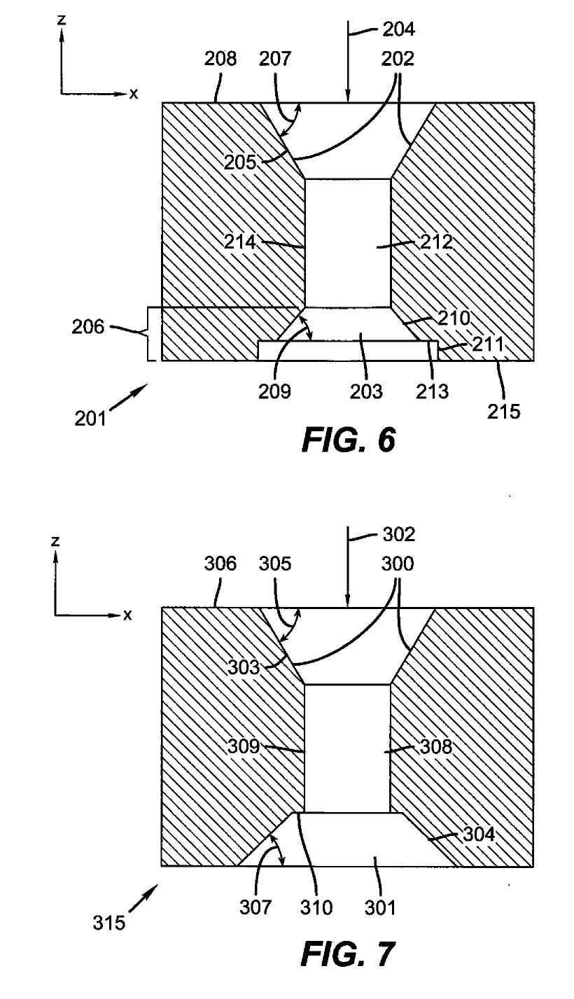

Referring to FIG. 6, another example embodiment of present invention is shown. Nozzle bore 201 includes a first section 202 and a second section 203 as viewed in a plane perpendicular to the nozzle plate at the inlet side 204. The first section 202 includes a converging area portion 205 and the second section 203 includes a diverging area portion 206. The converging area portion 205 includes an acute angle 207 relative to the surface 208 of nozzle plate 13. The diverging area portion 206 includes two sub-portions. The first sub-portion 210 includes an acute angle 209 relative to the surface of the nozzle plate, and the second sub-portion 211 includes a perpendicular angle 213 relative to the surface 208 (or surface 215) of nozzle plate 13. The first section 202 and the second section 203 are spaced apart from each other by a third section 212. The third section 212 includes a perpendicular area portion 214 perpendicular to the surface of the nozzle plate 208. The third section 212 can control the drop size, and drop direction. Sub-portion 211 of second section 203 helps maintain the jet filament length-of-break while sub-section 210 of second section 203 helps to control drop direction.

Referring to FIG. 7, another example embodiment of the present invention is shown. Nozzle bore 315 includes a first section 300 and a second section 301 as viewed in a plane perpendicular to the nozzle plate at the inlet side 302. The first section 300 includes a converging area portion 303 and the second section 301 includes a diverging area portion 304. The converging area portion 303 includes an acute angle 305 relative to the surface 306 of nozzle plate 13. The diverging area portion 304 includes an acute angle 307 relative to the surface 306 of nozzle plate 13. The first section 300 and the second section 301 are spaced apart from each other by a third section 308. The third section 308 includes a perpendicular portion 309 perpendicular to the surface of the nozzle plate 306. The third section 308 helps control drop size and drop jetting direction. A step 310 connects the third section 308 and the second section 301. Step 310 which is parallel to surface 306 of nozzle plate 13 helps to control jet filament length-of-break and drop size, while the diverging section 304 helps control or increase drop deflection.

Referring back to FIGS. 1A-7, nozzle plate 13 is typically made from silicon, steel, stainless steel, nickel, glass, plastic or other suitable materials. Nozzle plate 13 and nozzle bores 24 can be manufactured using electroplating, laser processing, chemical etching or other suitable manufacturing processes.

The invention has been described in detail with particular reference to certain example embodiments thereof, but it will be understood that variations and modifications can be effected within the scope of the invention.

### PARTS LIST

11 printhead
12 nozzle bore
13 nozzle plate
14 liquid flow source
15 outlet
16 fluidic supply channel
17 drops
18 liquid
19 drop-forming mechanism
21 surface
22 Cartesian coordinate system x-y-z
24 nozzle bore
50 nozzle bore
61 diverging area portion
62 second section
63 first section
64 perpendicular area portion
65 third section
66 ink inlet side
67 ink outlet side
68 surface
69 converging area portion
71 circular shape
72 Cartesian coordinate plane x-y
81 elliptical shape
82 Cartesian coordinate plane x-y
91 converging area portion
92 perpendicular area portion
93 diverging area portion
94 nozzle bore
95 first section
96 second section
97 acute angle
98 nozzle plate
99 acute angle
101 converging area portion
103 diverging area portion
104 nozzle bore
105 first section
106 second section
107 inlet side
108 acute angle
109 surface
110 acute angle
111 surface
201 nozzle bore
202 first section
203 second section
204 inlet side
205 converging area portion
206 diverging area portion
207 acute angle
208 surface
209 acute angle
210 first sub-portion
211 second sub-portion
212 third section
213 perpendicular angle
214 perpendicular area portion
215 surface
300 first section
301 second section
302 inlet side
303 converging area portion
304 diverging area portion
305 acute angle
306 surface
307 acute angle
308 third section
309 perpendicular portion
310 step
315 nozzle bore
401 ink
402 ink drop
403 liquid jet filament
407 contact angle
408 nozzle bore
510 quadrilateral shape
601 acute angle
602 acute angle
603 surface
901 third section
902 inlet side
903 surface

1. A printhead comprising:
a nozzle plate; and
a nozzle bore located in the nozzle plate, the nozzle bore including a first section, a second section, and a third section when viewed in a plane perpendicular to the nozzle plate, the first section and the second section being spaced apart from each other by the third section, the first section including a converging area portion, the second section including a diverging area portion.

2. The printhead of claim 1, the nozzle plate having a surface, wherein the diverging area portion includes an acute angle relative to the surface of the nozzle plate.

3. The printhead of claim 2, the diverging area portion including a surface having a continuous radius of curvature, wherein the acute angle of the diverging area portion is formed by the surface of the diverging area portion having the continuous radius of curvature.

4. The printhead of claim 1, the nozzle plate having a surface, wherein the third section includes at least one of a portion perpendicular to the surface of the nozzle plate and a portion including a non-perpendicular angle relative to the surface of the nozzle plate, the non-perpendicular angle of the portion of the third section being distinct relative to the acute angle of the diverging area portion.

5. The printhead of claim 1, wherein at least one of the converging area portion and the diverging area portion includes a surface having a continuous radius of curvature.

6. The printhead of claim 1, wherein the diverging area portion and the converging area portion are symmetrical relative to each other when viewed along a plane parallel to the nozzle plate.

7. The printhead of claim 1, wherein the diverging area portion and the converging area portion are asymmetrical relative to each other when viewed along the plane perpendicular to the nozzle plate.

8. The printhead of claim 1, wherein the nozzle bore includes one of a circular cross section, an elliptical cross section, and a quadrilateral cross section when viewed along a plane perpendicular to the nozzle plate.

9. The printhead of claim 1, wherein at least one of the converging area portion and the diverging area portion includes a surface having one of a hydrophilic and a hydrophobic coating.

10. The printhead of claim 1, further comprising a drop forming mechanism operatively associated with the nozzle bore.

11. The printhead of claim 10, wherein the drop forming mechanism is a heater.

12. The printhead of claim 1, wherein the converging area portion includes an acute angle relative to the surface of the nozzle plate.

13. The printhead of claim 1, wherein the diverging area portion includes a first sub-portion and a second sub-portions, the first sub-portion including the acute angle relative to the surface of the nozzle plate, the second sub-portion including a perpendicular angle relative to the surface of nozzle plate.

14. The printhead of claim 1, wherein the diverging area portion includes a first sub-portion and a second sub-portions, the first sub-portion including the acute angle relative to the surface of the nozzle plate, the second sub-portion including a step that is parallel to the surface of nozzle plate.

15. A method of ejecting a liquid drop from a printhead comprising:
providing a printhead including a nozzle plate; and a nozzle bore located in the nozzle plate, the nozzle bore including a first section, a second section, and a third section when viewed in a plane perpendicular to the nozzle plate, the first section and the second section being spaced apart from each other by the third section, the first section including a converging area portion, the second section including a diverging area portion;
providing a source of liquid in fluid communication with the printhead;
causing the liquid to be ejected through the nozzle bore of the printhead; and
causing a drop to form from the liquid by actuating a drop forming mechanism associated with the nozzle bore of the printhead.

16. A printhead comprising:
a nozzle plate; and
a nozzle bore located in the nozzle plate, the nozzle bore including a first section and a second section when viewed in a plane perpendicular to the nozzle plate, the first section and the second section being adjacent to each other, the first section including a converging area portion, the second section including a diverging area portion, the diverging area portion of the second section and the converging area portion of the first section being asymmetrical relative to each other when viewed along the plane perpendicular to the nozzle plate.

17. The printhead of claim 16, the nozzle plate having a surface, wherein at least one of the converging area portion and the diverging area portion includes an acute angle relative to the surface of the nozzle plate.

18. The printhead of claim 16, further comprising a drop forming mechanism including a heater operatively associated with the nozzle bore.

19. The printhead of claim 16, wherein the diverging area portion includes a first sub-portion and a second sub-portions, the first sub-portion including the acute angle relative to the surface of the nozzle plate, the second sub-portion including one of a step that is parallel to the surface of nozzle plate and a perpendicular angle relative to the surface of nozzle plate

20. A method of ejecting a liquid drop from a printhead comprising:
providing a printhead including a nozzle plate having a surface; and a nozzle bore located in the nozzle plate, the nozzle bore including a first section and a second section when viewed in a plane perpendicular to the nozzle plate, the first section and the second section being adjacent to each other, the first section including a converging area portion, the second section including a diverging area portion, the diverging area portion of the second section and the converging area portion of the first section being asymmetrical relative to each other when viewed along the plane perpendicular to the nozzle plate;
providing a source of liquid in fluid communication with the printhead;
causing the liquid to be ejected through the nozzle bore of the printhead; and
causing a drop to form from the liquid by actuating a drop forming mechanism associated with the nozzle bore of the printhead.
